(19) United States
(12) Patent Application Publication
(10) Pub. No.: US 2018/0201414 A1
(43) Pub. Date: Jul. 19, 2018

(54) Improvements In or Relating to Closures

(71) Applicant: Obrist Closures Switzerland GmbH, Reinach (CH)

(72) Inventor: Alexandre Rouquette, Mulhouse (FR)

(73) Assignee: Obrist Closures Switzerland GmbH, Reinach (CH)

(21) Appl. No.: 15/742,351

(22) PCT Filed: Jul. 8, 2016
(86) PCT No.: PCT/EP2016/066308

§ 371 Date: Jan. 5, 2018

(30) Foreign Application Priority Data
Jul. 8, 2015 (GB) 1511915.9

(51) Int. Cl. B65D 41/34; B65D 51/24; G06F 3/039

(52) U.S. Cl. CPC B65D 41/3447; B65D 2203/00; G06F 3/039; B65D 51/245

(57) ABSTRACT

A container closure is provided and comprises a shell with a skirt for securement to a container neck finish, a tamper-evident means for indicating if the closure has been removed from a container in use and electrically conductive multi-touch contact points co-axially located around the skirt.

The present invention relates generally to closures, for example beverage closures.

The present invention may relate generally to the principle of making use of the “multi touch” capabilities of a smart phone/tablet to unlock promotional activities for a consumer.

Multi-touch is technology that enables a surface (such as a trackpad or touchscreen) to recognise the presence of more than one point of contact with the surface. This plural-point awareness may be used, for example, to implement additional functionality, such as pinch to zoom or to activate certain subroutines attached to predefined gestures.

According to an aspect of the present invention there is provided a container closure comprising two or more multi-touch contact points.

According to a further aspect there is provided a container closure comprising a shell with a skirt for securement to a container neck finish, a tamper-evident means for indicating if the closure has been removed from a container in use and electrically conductive multi-touch contact points co-axially located around the skirt.

Aspects and embodiments of the present invention may relate to ways of interacting with smart devices (phones/tablets) with packaging; somehow using conductivity in the packaging to activate promotional items through an app.

The present invention may be based on “multi touch events” capability of the smart screens.

In some embodiments the contact points are usable only after removal of the closure from a container in use. For example the points may be positioned at or towards the free end of a closure shell sidewall (for example being “downwardly” extending”) so that they cannot collectively touch a screen until the shell is removed.

The closure may comprise tamper-evident means for indicating if the closure has been removed from a container in use. For example a tamper-evident drop band may be provided at the free end of a shell sidewall.

The closure may comprise a body part and a contact point bearing part.

Like in a stylus or gloves that can be used with smart devices, the closure needs to be conductive using the contact with the consumer's hand to work. This may, for example, mean using an additive in the polymer, which are typically not direct food contact approved.

The material from which a body part and a contact bearing part may be different.

The device screen may be actuated by conductivity. In some embodiments an appropriate additive is used in the closure to provide the conductivity. Multiple conductive materials are available, but none are FDA approved for direct food contact.

At least part of the closure is formed from a conductive material, for example the contact points may be formed from a conductive material. In some embodiments, where provided, the contact point bearing part may be formed from a conductive material.

By providing, for example, a non-product contacting contact bearing part it can be formed from a conductive material, whilst a product contacting body part can be formed from non-conductive food grade material.

The contact point bearing part may, for example comprise a ring or an overcap.

In some embodiments the contact bearing part is overmoulded onto the body, for example using a sequential moulding process. In other embodiments the contact bearing part is formed separately from and is connectable to the body, for example being irreversibly connectable to the body to prevent removal.

The contact points may be positioned at or towards the free end of a closure shell sidewall or towards the distal end of the contact point bearing ring.

In some embodiments a contact point bearing ring part may be attached to a closure between a tamper evident band and a body part.

The closure is formed from a plastics material, for example polypropylene or polyethylene.

In some embodiments the closure is formed with a screw thread for engaging a container neck. An internal screw thread provided on a sidewall may be preferred.

In some embodiments three contact points are provided. For example three points may be mutually spaced at circumferential intervals of approximately 120 degrees.

A further aspect provides a promotional beverage container closure, comprising a shell and a separate part comprising a plurality of multi-touch contact points, the shell being formed from non-conductive material and the separate part being formed from conductive material.

The present invention also provides a closure as described herein in combination with a container.

In some embodiments an overcap approach is used—something that clips over a standard closure but with the designed multiple contact points to be the key on the device.

In some embodiments the closure is used as the key to unlock promotions for consumers with the winning closures.

Multiple orientations of the touch points may be required.

In some embodiments the closure has full carbonated soft drink (CSD) functionality.

Aspects and embodiments of the present invention may, for example, relate to carbonated soft drinks (CSD) closures, mineral water closures, sportscaps, tamper-evident closures, spirits bottle closures and the like.

Different aspects and embodiments of the invention may be used separately or together.

Further particular and preferred aspects of the present invention are set out in the accompanying independent and dependent claims. Features of the dependent claims may be combined with the features of the independent claims as appropriate, and in combinations other than those explicitly set out in the claims.

The present invention will now be more particularly described, by way of example, with reference to the accompanying drawings.

The example embodiments are described in sufficient detail to enable those of ordinary skill in the art to embody and implement the systems and processes herein described. It is important to understand that embodiments can be provided in many alternative forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In the following description, all orientational terms, such as upper, lower, top, bottom, radially and axially, are used in relation to the drawings and should not be interpreted as limiting on the invention.

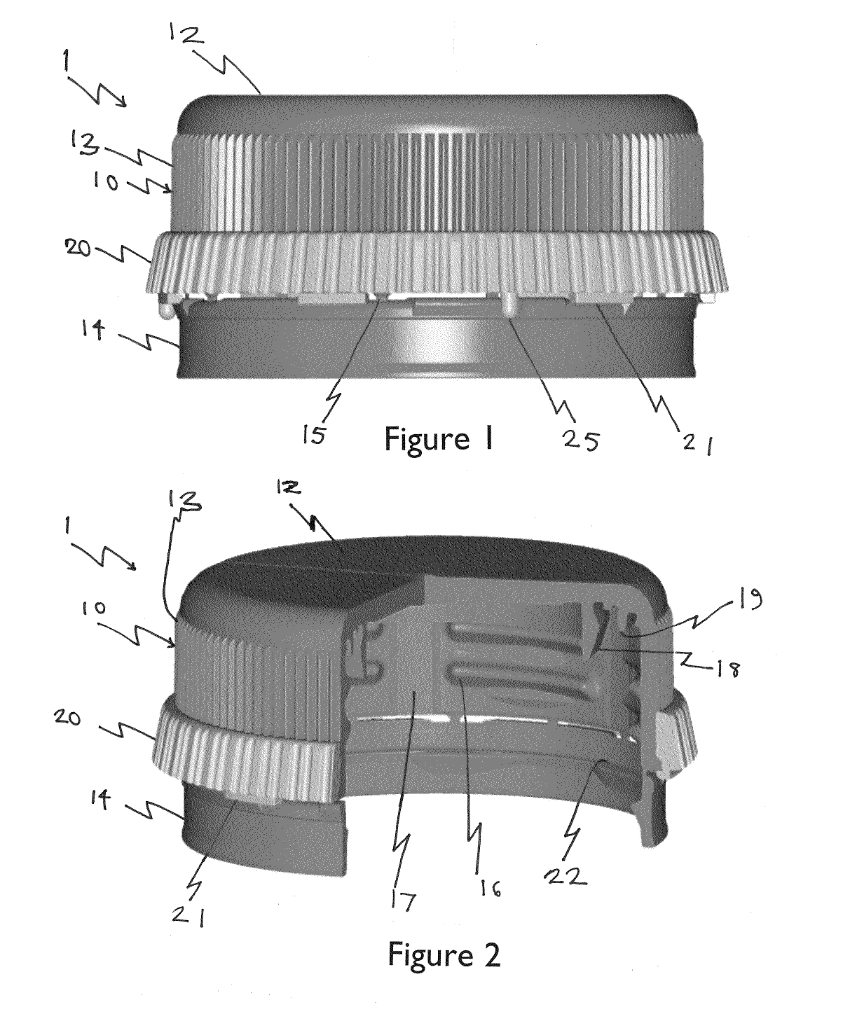

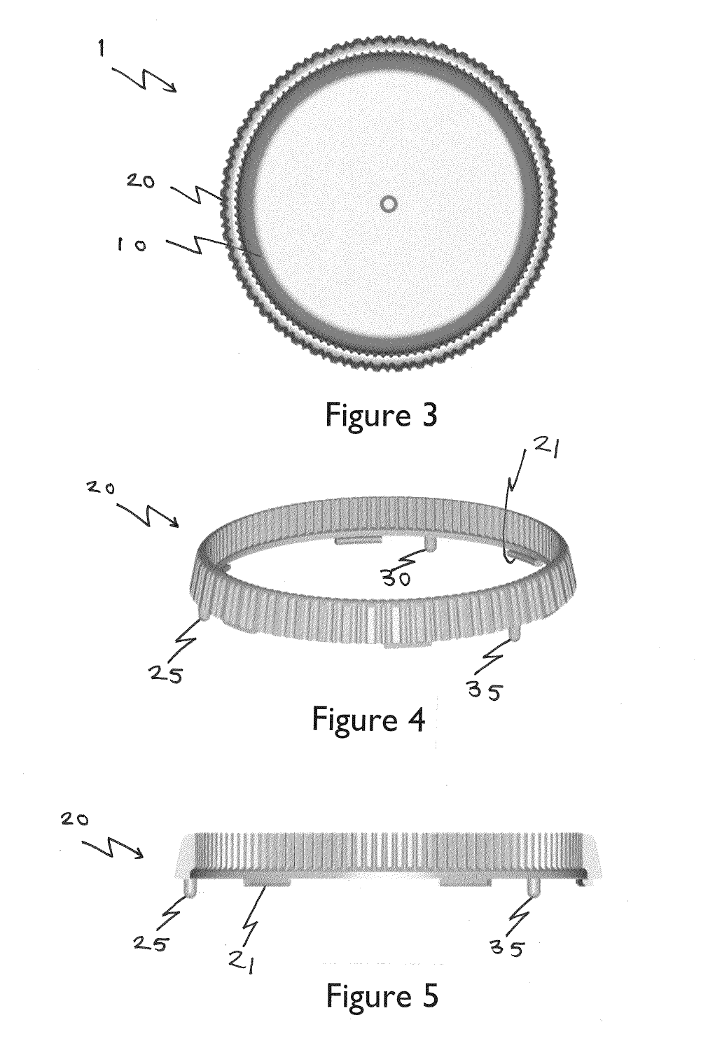

In the “inverted” promotional closure 1 shown in FIGS. 1 to 3, a very cost effective solution is provided, that also requires the product to be purchased. Rather than the contact points on the top of an overcap, they are accessed only when the closure is removed from the bottle and the contact points exposed at the bottom of the shell.

In his embodiment a standard screw threaded carbonated soft drink closure 10 is provided and comprises a shell 11 with a top plate 12 and a depending side skirt 13. A tamper-evident drop band 14 is frangibly connected at the bottom of the shell skirt by frangible bridges 15. The band 14 includes interior lugs 22 which pass over (when the closure is fitted) and engage under a bead on a container neck finish in use; thereafter they prevent the band moving upwards with the rest of the closure when unscrewed to cause breakage of the bridges 15 and release of the band in use.

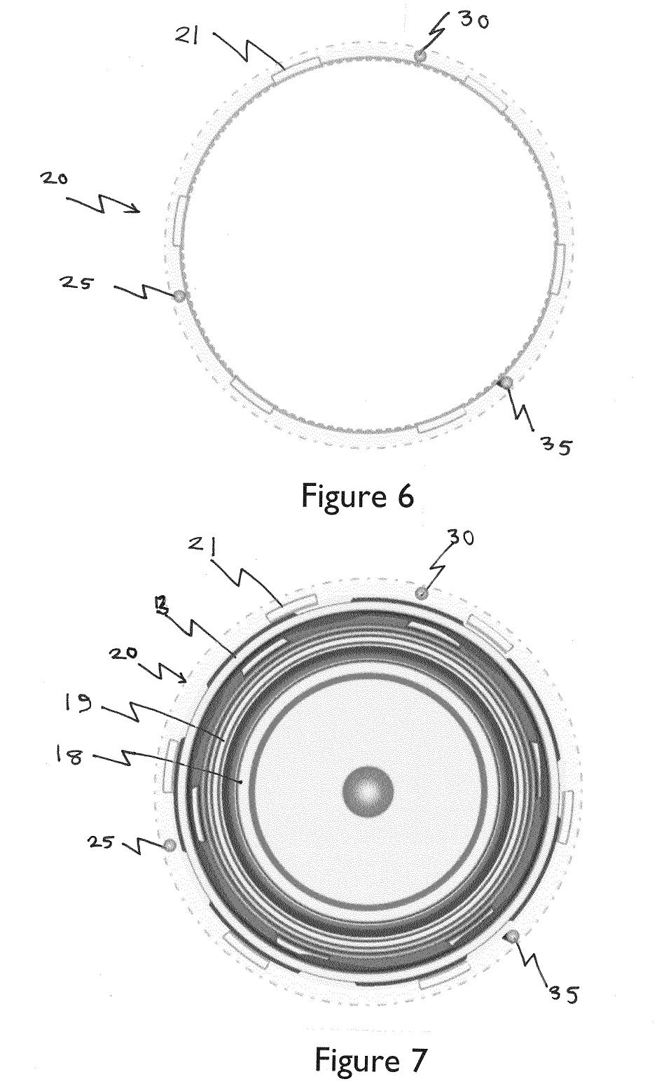

In this embodiment a functional over-ring 20 is provided (FIGS. 4 to 6) with the required contact points 25, 30, 35 on the underside.

The ring 20 is mechanically clipped to the exterior of the closure shell 12 and includes hooks 21 which clip under the free end of the skirt 13. The overcap 20 is thereby clipped by the hooks onto the closure shell. The contact points extend below the ring.

The ring 20 is formed as an ultra-lightweight concept with conductive material.

The closure shell 12 has to be removed to access the functionality of the ring—this ensures consumers buy the product before they can play.

The interior of the shell is provided with an interior screw thread 16 on the skirt 13, with vent slots 17. Depending from the underside of the top plate 12 is a circumferential inner olive seal 18 and an annular outer seal 19.

In use the closure 1 is opened by rotating the shell 12 (together with the ring) which causes the band 14 to break away from the free end of the shell 12 and remain on a bottle. The shell 12 can be removed together with the ring (FIG. 7), which exposes the contact points at the bottom of the shell so that they can interact with a smart device.

This embodiment is therefore based on the idea that it is first necessary to unscrew the cap and only then can the contact points can interact with an electronic device.

Although an illustrative embodiment of the invention has been disclosed in detail herein, with reference to the accompanying drawings, it is understood that the invention is not limited to the precise embodiment shown and that various changes and modifications can be effected therein by one skilled in the art without departing from the scope of the invention.

1. A container closure comprising a shell with a skirt for securement to a container neck finish, a tamper-evident means for indicating if the closure has been removed from a container in use and electrically conductive multi-touch contact points co-axially located around the skirt.

2. A closure as claimed in claim 1, in which the contact points are usable only after removal of the closure from a container in use.

3. A closure as claimed in claim 1, in which the closure comprises a body part, a tamper evident band frangibly connected to the body part and a contact point bearing part.

4. A closure as claimed in claim 3, in which material from which the body part and contact bearing part is different.

5. A closure as claimed in claim 3, in which the contact point bearing part comprises a ring.

6. A closure as claimed in claim 1, in which the contact point bearing part comprises an overcap.

7. A closure as claimed in claim 1, wherein the contacts points are positioned at or towards the free end of a closure shell sidewall or towards the distal end of the contact point bearing ring.

8. A closure as claimed in claim 1, in which contact bearing part is formed separately from and is connectable to the body.

9. A closure as claimed in claim 1, wherein contact point bearing ring part is attached to the closure between the tamper evident band and the body part.

10. A closure as claimed in claim 1, in which contact bearing part is irreversibly connectable to the body.

11. A closure as claimed in claim 10, in which the contact bearing part is overmoulded onto the body.

12. A closure as claimed in claim 1, in which the contact points are formed from a conductive material.

13. A closure as claimed in claim 1, in which the contact point bearing part is formed from a conductive material.

14. A closure as claimed in claim 1, in which the closure is formed from a plastics material.

15. A closure as claimed in claim 1, in which three contact points are provided.

16. A closure as claimed in claim 15, in which the points are mutually spaced at circumferential intervals of approximately 120 degrees.

17. A promotional beverage container closure, comprising a shell and a separate part comprising a plurality of electrically conductive multi-touch contact points, the shell being formed from non-conductive material and the separate part being formed from conductive material.

18. (canceled)

19. A closure as claimed in claim 1 in combination with a container.

20. An overcap ring comprising a plurality of electrically conductive multi-touch contact points for positioning onto a standard screw threaded carbonated soft drinks closure.

21. (canceled)
